(19) United States
(12) Patent Application Publication
(10) Pub. No.: US 2008/0173216 A1
(43) Pub. Date: Jul. 24, 2008

(54) Process for forming electrodeposition coating film

(76) Inventors: Keisuke Tsutsui, Aichi (JP); Kenichi Yoshizawa, Fukuoka (JP); Koichi Suda, Osaka (JP); Koji Izumiya, Aichi (JP)

Correspondence Address: WENDEROTH, LIND & PONACK, L.L.P., 2033 K STREET N. W., SUITE 800, WASHINGTON, DC, 20006-1021, US

(21) Appl. No.: 12/007,858

(22) Filed: Jan. 16, 2008

(30) Foreign Application Priority Data
Jan. 18, 2007 (JP) 2007-8990

(51) Int. Cl. C25D 3/22; C09D 11/10; C09D 11/02

(52) U.S. Cl. 106/287.18; 205/316; 524/413

(57) ABSTRACT

The present invention is intended to provide a process for forming an electrodeposition coating film, wherein generation of gas pinhole is reduced and coating film appearance is excellent without using a specific resin as a binder resin.

The present invention relates a process for forming an electrodeposition coating film having reduction of generation of gas pinhole, comprising a step of electrocoating by immersing an article to be coated in a cationic electrodeposition coating composition, wherein,
the cationic electrodeposition coating composition comprises 10 to 30 parts by weight of a pigment comprising zinc oxide based on 100 parts by weight of a solid content of the coating composition, and the content of zinc oxide contained in the pigment is 0.25 to 5 parts by weight based on 100 parts by weight of the pigment.

### FIELD OF THE INVENTION

The present invention relates to a process for forming an electrodeposition coating film, wherein generation of gas pinholes is reduced and coating film appearance is excellent, and a process for improving the storage stability of a pigment dispersed paste.

### BACKGROUND OF THE INVENTION

Since cationic electrodeposition coating can carry out coating to minutiae even if an article to be coated has a complicated shape and can coat it automatically and continuously, it is widely used practically as the undercoating method of a large scale coated article having a complicated shape such as the car body of an automobile in particular. The cationic electrodeposition coating is carried out by immersing the article to be coated in a cationic electrodeposition coating composition as a cathode and applying voltage to it.

The deposition of a coating film in the process of the cationic electrodeposition coating is caused by an electrochemical reaction and the coating film is deposited on the surface of the article to be coated. Since the coating film deposited has insulation, the electric resistance of the coating film is enlarged in accordance with increase of a deposited film in the progression of the deposition of the coating film in an electrodeposition coating process. As a result, the deposition of the coating composition at a site where the coating film is deposited is lowered and in its behalf, the deposition of the coating film starts to be deposited on a non-deposited site. Thus, coating is completed by the deposition of a solid content of a coating composition on the coated article in order. In the present specification, property in which the coating film is formed in order at the non-deposited site of the coated article is called as throwing power.

Since an electrodeposition coating composition having high throwing power forms an electrodeposition coating film even at a position far from an electrode portion, it is preferable that a portion with no coating can be lessened. However, when the electric resistance value of the coating film is merely raised for securing the throwing power in the electrodeposition coating, applied voltage at the electrodeposition coating is heightened and it is not preferable because “gas pinholes” presumably caused by hydrogen gas generated at electrodeposition are generated and the deterioration of coating film appearance occurs.

Additionally, the electrodeposition coating on a zinc coated steel plate on which zinc was coated has been increased recently. The zinc coated steel plate is superior in anticorrosion property in comparison with a usual steel plate. When it is used as an article to be coated, there is an advantage that higher anticorrosion property can be realized. On the other hand, when the zinc coated steel plate is used as the coated article, there are problems that gas pinhole and craters are easily generated on the electrodeposition coating film obtained and bad appearance occurs easily. Its reason is considered that since the discharge voltage of hydrogen gas generated at the coated article side at cationic electrodeposition coating is lower than that of the steel plate, spark discharge in hydrogen gas is easily generated in hydrogen gas. An electrodeposition coating method by which gas pinhole is hardly generated even at the electrodeposition coating of the zinc coated steel plate has been desired.

Japanese Patent Kokai Publication No. 2006-002003 (Patent Literature 1) describes a cationic electrodeposition coating composition and a process for forming an electrodeposition coating film by which the generation of gas pinhole is reduced, according to the proposal of the present applicant. The invention described in the patent literature is an invention using a specific resin as a binder resin, and its structure is different from the present invention.

Japanese Patent Kokai Publication No. Hei 7 (1995)-53902 (Patent Literature 2) describes an electrodeposition coating composition wherein 0.5 to 10 parts by weight of zinc oxide obtained by coating the surface thereof with a siloxane inorganic compound and/or an acrylic organic compound is contained per 100 parts by weight of the resin solid content of the composition. Japanese Patent Kokai Publication No. Hei 9 (1997)-124979 (Patent Literature 3) describes a cationic electrodeposition coating composition containing phosphomolybdate and it is described that the phosphomolybdate is preferably the complex of aluminum phosphomolybdate and zinc oxide. Furthermore, Japanese Patent Kokai Publication No. 2006-137863 (Patent Literature 4) describes a lead-free cationic electrodeposition coating composition containing a complex compound of condensed metal phosphorate with zinc oxide. The zinc compounds described in these patent literatures 2 to 4 are used as an anticorrosion pigment and the technical effect obtained is different from the effects of the suppression of gas pinhole generation and the improvements of coating film appearance and the storage stability of a pigment dispersed paste that are the technical effects of the present invention.

Japanese Patent Kokai Publication No. 2002-294141 (Patent Literature 5) describes a cationic electrodeposition coating composition containing (1) an amine-modified epoxy resin, (2) a blocked isocyanate curing agent blocking aromatic isocyanate with at least a lactam blocking agent and (3) a curing accelerator containing at least one kind selected from the group consisting of a copper catalyst, a zinc catalyst and a tin catalyst. Herein, the zinc catalyst acts as a curing accelerator and its subject and technical effect obtained are different from the present invention.

Japanese Patent Kokai Publication No. 2005-41951 (Patent Literature 6) describes a cationic electrodeposition coating composition in which aromatic blocked isocyanate is contained by 70 to 90% by mass as blocked isocyanate, its blocking agent is a C4 to C10 ethylene glycol ether compound, a pigment dispersed paste contains 40 to 50% by mass of filler pigment whose oil absorption amount is 60 to 100 ml/100 g in the whole pigments, the solid content concentration of the pigment dispersed paste is 55 to 58% by weight and the concentration of zinc ion in the coating composition is 450 to 500 ppm. Herein, zinc ion expresses action of preventing sagging and pinhole and the subject and technical effect obtained are different from those of the present invention.

### [Patent Literature 1]. JP-A-2006-002003

### [Patent Literature 2] JP-A-Hei 7 (1995)-53902

### [Patent Literature 3] JP-A-Hei 9 (1997)-124979

### [Patent Literature 4] JP-A-2006-137863

### [Patent Literature 5] JP-A-2002-294141

### [Patent Literature 6] JP-A-2005-41951

### OBJECTS OF THE INVENTION

The present invention solves the above-mentioned conventional problems and its object is to provide a process for forming an electrodeposition coating film wherein generation of gas pinhole is reduced and coating film appearance is excellent without using a specific resin as a binder resin, and a process for improving storage stability of a pigment dispersed paste.

### SUMMARY OF THE INVENTION

The present invention provides a process for forming an electrodeposition coating film having reduction of generation of gas pinhole, comprising a step of electrocoating by immersing an article to be coated in a cationic electrodeposition coating composition, wherein, the cationic electrodeposition coating composition comprises 10 to 30 parts by weight of a pigment comprising zinc oxide based on 100 parts by weight of a solid content of the coating composition, and the content of zinc oxide contained in the pigment is 0.25 to 5 parts by weight based on 100 parts by weight of the pigment, and thereby, the above-mentioned object can be achieved.

The cationic electrodeposition coating composition may preferably be a cationic electrodeposition coating composition containing an amine-modified epoxy resin (1), a blocked isocyanate curing agent (2) and a pigment comprising zinc oxide (3), and at least one kind selected from the group consisting of aromatic polyisocyanate, aliphatic polyisocyanate and alicyclic polyisocyanate may preferably be contained as the polyisocyanate constituting (2) the blocked isocyanate curing agent and at least one kind selected from the group consisting of a glycol blocking agent, a lactam blocking agent, an oxime blocking agent and a glycol ether blocking agent may preferably be contained as a blocking agent for blocking the polyisocyanate.

Furthermore, the blocked isocyanate curing agent (2) may preferably be a blocked isocyanate curing agent in which aromatic isocyanate may preferably be blocked with at least a lactam blocking agent, a glycol ether blocking agent or a glycol blocking agent, or preferably a blocked isocyanate curing agent in which alicyclic polyisocyanate may preferably be blocked with at least an oxime blocking agent or a glycol ether blocking agent.

Furthermore, the cationic electrodeposition coating composition may preferably be a cationic electrodeposition coating composition prepared by mixing a binder resin emulsion containing the amine-modified epoxy resin (1) and the blocked isocyanate curing agent (2) with a pigment dispersed-paste containing the pigment (3) containing zinc oxide.

Furthermore, the present invention provides also a coating film obtained by the process for forming an electrodeposition coating film.

Furthermore, the present invention provides also a process for improving gas pinhole performance at electrodeposition coating, coating film appearance and storage stability of a pigment dispersed paste, wherein the cationic electrodeposition coating composition used in an electrodeposition coating step comprises 10 to 30 parts by weight of pigment containing zinc oxide based on 100 parts by weight of a solid content of the coating composition and a content of zinc oxide contained in the pigment may preferably be 0.25 to 5 parts by weight based on 100 parts by weight of the pigment.

According to the present invention, the generation of gas pinhole can be reduced in formation of an electrodeposition coating film without preparing an electrodeposition coating composition containing a specific binder. The present invention has an advantage that the generation of gas pinhole can be reduced without affecting the physical property of a coating film such as corrosion resistance. Furthermore, the process for forming an electrodeposition coating film of the present invention also has an advantage that a coating film superior in coating film appearance is obtained. The process for forming an electrodeposition coating film of the present invention is superior in performance of reducing gas pinhole defects (occasionally abbreviated as gas pinhole performance in the present specification), and can be preferably used for coating of a zinc coated steel plate.

### BRIEF DESCRIPTION OF THE DRAWING

FIG. 1 is a schematic diagram showing the brief summary of a throwing power measurement device.

### EXPRESSION OF REFERENCE LETTERS

201: Electrodeposition coating container
202: Pipe
203: Evaluation plate
204: Liquid surface
205: Stirrer
206: Power source
207: Electrodeposition coating composition

### DETAILED DESCRIPTION OF THE PREFERRED EMBODIMENTS

Electrodeposition Coating Composition

The cationic electrodeposition coating composition of the present invention contains an aqueous medium, a binder resin emulsion dispersed in the aqueous medium, a pigment dispersed paste containing a pigment containing zinc oxide, a neutralizing acid and an organic solvent. The binder resin contained in the binder resin emulsion is resin components made of an amine-modified epoxy resin (1) and a blocked isocyanate-curing agent (2).

Pigment

The electrodeposition coating composition of the present invention contains a pigment. The pigment contains zinc oxide. In the present invention, an electrodeposition coating film superior in coating film appearance, gas pinhole performance and the like can be formed by using the electrodeposition coating composition containing a pigment containing 0.25 to 5 parts by weight of zinc oxide based on 100 parts by weight of the pigment. When the amount of zinc oxide is less than 0.25 part by weight based on 100 parts by weight of the pigment, the effect of good coating film appearance and gas pinhole performance is not obtained. Furthermore, when the amount of zinc oxide exceeds 5 parts by weight based on 100 parts by weight of the pigment, there is a defect such that the viscosity of the pigment dispersed paste prepared at the production of the electrodeposition coating composition is heightened.

Examples of the pigments other than zinc oxide include pigments which can be usually used, for example, coloring-pigments such as titanium white, carbon black and colcothar; filler pigments such as kaolin, talc, aluminum silicate, calcium carbonate, mica and clay; anticorrosive pigments such as zinc phosphate, iron phosphate, aluminum phosphate, calcium phosphate, zinc phosphite, zinc cyanide, aluminum tripolyphosphate, zinc molybdate, aluminum molybdate, calcium molybdate, aluminum phosphomolybdate, aluminum zinc phosphomolybdate, and the like.

The content of the pigment in the electrodeposition coating composition is 10 to 30 parts by weight based on 100 parts by weight of a solid content of the coating composition of the electrodeposition coating composition, The content may more preferably be 15 to 25 parts by weight based on 100 parts by weight of a solid content of the coating composition of the electrodeposition coating composition. When the content of the pigment exceeds 30 parts by weight, level appearance of the coating film obtained may be lowered being subjected to the influence of accumulation of the pigment during coating. Furthermore, when the content of the pigment is less than 10 parts by weight, anti-cissing property and anticorrosion property may be lowered.

These pigments are generally dispersed in an aqueous medium at high concentration preliminarily to be a paste (pigment dispersed paste) and the electrodeposition coating composition is prepared using the pigment dispersed paste. Since the pigments are powder, it is difficult to disperse them at one step in a uniform state at low concentration used for the electrodeposition coating composition.

The pigment dispersed paste is prepared by dispersing pigments together with a pigment dispersing resin in an aqueous medium. As the pigment dispersing resin, cationic or nonionic low molecular weight surfactant, or a cationic polymer such as a modified epoxy resin and the like having a quaternary ammonium group and/or a tertiary-sulfonium group is used. As the aqueous medium, ion exchanged water, water containing a small amount of alcohols and the like are used.

The pigment dispersing resin is used in an amount of 20 to 100 parts by weight of solid content ratio based on 100 parts by mass of the pigments. The pigment dispersed paste is prepared by mixing the pigment dispersing resin with the pigment, and thereafter dispersing them using a usual dispersion device such as a ball mill or a sand grind mill until the particle diameter of the pigments in the mixture becomes an intended uniform particle diameter.

As a means for reducing the generation of gas pinhole in electrodeposition coating, a technique of lowering the film resistance of a coating film obtained by a coating composition is adopted in general. The examples of these procedures include a method of using a soft resin in combination as the binder resin, a method of lowering a concentration of a pigment, a method of adding a solvent with a high boiling point, and the like. Furthermore, as a technique of improving coating film appearance of an electrodeposition coating film, a technique of highly producing heat flow at curing heating cased by using a soft resin in combination as the binder resin and thereby, improving the coating film appearance, and the like may be used. However, by using these means, it may involve defects such that physical properties of a coating film such as the corrosion resistance of a coating film and mechanical strength are lowered, and throwing power is lowered.

In contrast, the process for forming the electrodeposition coating film of the present invention does not require change of the composition of the above-mentioned binder resin, lowering of a pigment concentration, or addition of a solvent with a high boiling point. The present invention requires using a specific amount of 0.25 to 5 parts by weight of zinc oxide based on 100 parts by weight of the pigment, and the process has superior effects such that coating film appearance is improved and generation of gas pinhole can be reduced in forming the electrodeposition coating film. The process of the present invention has an advantage such that the coating film appearance can be improved, and the generation of gas pinhole can be reduced without accompanying defects such as lowering of the physical properties of a coating film such as anticorrosion property and mechanical strength, and lowering of throwing power.

The electrodeposition coating composition used in the present invention has also an advantage such that the increase of viscosity and the increase of granules caused by the thickening of a pigment dispersed paste used for the preparation of the electrodeposition coating composition is reduced. The technical effect is an effect that is obtained by using the pigment containing 0.25 to 5 parts by weight of zinc oxide based on 100 parts by weight of the pigment in the electrodeposition coating composition. Zinc oxide containing zinc having larger ionization tendency than iron has performance as anticorrosion pigment providing corrosion resistance, and on the other hand, it has a defect such that when used in the electrodeposition coating composition, its viscosity is increased. The problem of viscosity increase is also described in the 0015 paragraph of Japanese Patent Kokai Publication No. 2006-137863 (Patent-Literature 4) and the 0003 paragraph of Japanese Patent-Kokai Publication No. Hei 7 (1995)-53902 (Patent Literature 2). For these defects, the present invention has also found an technical effect that the increase of viscosity caused by thickening of a pigment dispersed paste can be reduced by using a pigment containing 0.25 to 5 parts by weight of zinc oxide based on 100 parts by weight of the pigment in the electrodeposition coating composition and the storage stability of the pigment dispersed paste can be improved. Since the storage stability of the pigment dispersed paste is improved, there is an industrial advantage such that the preparation of the electrodeposition coating composition becomes easier.

Amine-Modified Epoxy Resin (1)

The amine-modified epoxy resin (1) used in the present invention may preferably be a bisphenol type epoxy resin modified with amine. The amine-modified epoxy resin (1) is typically made by opening all epoxy rings of the bisphenol type epoxy resin with amine, or by opening a part of the epoxy rings with another activated hydrogen compound and opening the residual epoxy rings with amine.

A typical example of the bisphenol type epoxy resin is bisphenol A type epoxy resin or bisphenol F type epoxy resin. The commercially available product of the former includes Epikote 828 (manufactured by Yuka Shell Epoxy Co., Ltd.; epoxy equivalent value: 180 to 190), Epikote 1001 (manufactured by Yuka Shell Epoxy Co.; epoxy equivalent value: 450 to 500), Epikote 1010 (manufactured by Yuka Shell Epoxy Co.; epoxy equivalent value: 3000 to 4000), and the like, and the commercially available product of the latter includes Epikote 807 (manufactured by Yuka Shell Epoxy Co.; epoxy equivalent value: 170), and the like.

An oxazolidone ring-containing epoxy resin indicated by the following formula that is described in Japanese Patent Kokai Publication No. Hei 5 (1995)-306327:

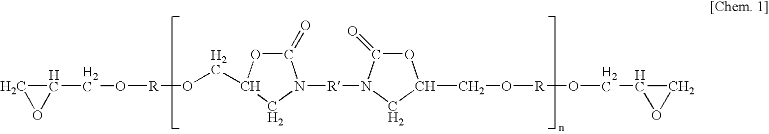

wherein R means a residual group excluding the glycidyloxy group of a diglycidylepoxy compound, R′ means a residual group excluding the isocyanate group of a diisocyanate compound, and n means a positive integer, may be used as the amine-modified epoxy resin (1). This is because a coating film superior in heat resistance and anticorrosion property can be obtained. Japanese Patent Kokai Publication No. Hei 5 (1993)-306327 is a priority patent application of U.S. Pat. No. 5,276,072, which is herein incorporated by reference.

An example of a method of introducing the oxazolidone ring into an epoxy resin includes a method containing the steps of heating the blocked isocyanate curing agent blocked with a lower alcohol such as methanol and polyepoxide under a basic catalyst and keeping a temperature constant, and evaporating the lower alcohol as a byproduct from the system.

A particularly preferable epoxy resin is an oxazolidone ring-containing epoxy resin. Because a coating film superior in heat resistance and corrosion resistance and furthermore superior in impact resistance can be obtained.

When a bifunctional epoxy resin is reacted with diisocyanate (that is, bisurethane) blocked with a monoalcohol, it is well known that an oxazolidone ring-containing an epoxy resin is obtained. A concrete example and a production process of the oxazolidone ring-containing epoxy resin are described in, for example, the 0012 to 0047 paragraphs of Japanese Patent Kokai Publication No. 2000-128959 and well known. Japanese Patent Kokai Publication No. 2000-128959 is a priority patent application of U.S. Pat. No. 6,664,345, which is herein incorporated by reference.

The epoxy resin may be modified with a suitable resin such as a polyester polyol, polyether polyol and monofunctional alkylphenol. Furthermore, the chain of the epoxy resin can be elongated by utilizing a reaction of an epoxy group with diol or dicarboxylic acid.

It is desired for the epoxy resin to be ring-opened with an activated hydrogen compound such that they have an amine equivalent value of 0.3 to 4.0 meq/g after ring opening, and particularly, 5 to 50% thereof is a primary amine group.

Amine reacting with epoxy groups in the epoxy resin includes primary amine and secondary amine. When the epoxy resin is reacted with the secondary amine, an amine-modified epoxy resin having tertiary amino group is obtained. Furthermore, when the epoxy resin is reacted with the primary amine, an amine-modified epoxy resin having secondary amino group is obtained. Furthermore, an amine-modified epoxy resin having primary amino group can be prepared by using a component having primary amino group and secondary amino group. Herein, the amine-modified epoxy resin having primary amino group can be prepared by using the component having primary amino group and secondary amino group which has blocked primary amino group with ketone and converted to ketimine before reacting with the epoxy resin and introducing this into the epoxy resin, then carrying out deblocking.

An example of the primary amine, the secondary amine or ketimine includes, for example, butyl amine, octylamine, diethylamine, dibutylamine, methylbutylamine, monoethanolamine, diethanolamine, N-methylethanolamine and the like. Furthermore, it includes secondary amines having primary amine blocked, such as ketimine of aminoethylethanolamine and diketimine of diethylenetriamine. 2 or more of these amines may be used in combination.

Blocked Isocyanate Curing Agent (2)

The blocked isocyanate curing agent (2) is prepared by blocking polyisocyanate with a blocking agent. The polyisocyanate means a compound having 2 or more of isocyanate groups in a molecule. As the polyisocyanate, for example, an aliphatic based, an alicyclic based, an aromatic based and an aromatic-aliphatic based polyisocyanates may be mentioned.

An example of the polyisocyanate includes aromatic diisocyanates such as tolylene diisocyanate (TDI), diphenylmethane diisocyanate (MDI), p-phenylene diisocyanate and naphthalene diisocyanate; aliphatic diisocyanates having 3 to 12 carbon atoms such as hexamethylene diisocyanate (HDI), 2,2,4-trimethylhexane diisocyanate and lysine diisocyanate; alicyclic diisocyanates having 5 to 18 carbon atoms such as 1,4-cyclohexane diisocyanate (CDI), isophorone diisocyanate (IPDI), 4,4′-dicyclohexylmethane diisocyanate (hydrogenated MDI), methylcyclohexane diisocyanate, isopropylidene dicyclohexyl-4,4′-diisocyanate, and 1,3-diisocyanatomethylcyclohexane (hydrogenated XDI), hydrogenated TDI, and 2,5- or 2,6-bis(isocyanatomethyl)-bicyclo[2.2.1]heptane (also called as norbornene diisocyanate); aliphatic diisocyanates having an aromatic ring such as xylylene diisocyanate (XDI) and tetramethylxylylene diisocyanate (TMXDI); the modified products of these diisocyanates (urethanated product, carbodiimide, urethodione, urethoimine, biuret and/or isocyanurate modified product), etc. These can be used alone or 2 or more can be used in combination.

An adduct or a prepolymer which is obtained by reacting polyisocyanate with polyvalent alcohols such as ethylene glycol, propylene glycol, trimethylolpropane and hexanetriol at an NCO/OH ratio of 2 or more may be also used for the blocked isocyanate curing agent.

The blocked isocyanate curing agent (2) is prepared by blocking the polyisocyanate with a blocking agent. Herein, the blocking agent is added to a polyisocyanate group and stable at normal temperature, but is a compound that can regenerate a free isocyanate group when it is heated to dissociation temperature or more.

The polyisocyanate constituting the blocked isocyanate curing agent (2) includes at least one selected from the group-consisting of aromatic polyisocyanate, aliphatic polyisocyanate and alicyclic polyisocyanate, and the blocking agent blocking the polyisocyanate may preferably include at least one selected from the group consisting of a glycol blocking agent, a lactam blocking agent, an oxime blocking agent and a glycol ether blocking agent.

Herein, an example of the glycol blocking agent includes propylene glycol, butylene glycol and the like.

The example of the lactam blocking agent includes ε-caprolactam, δ-valerolactam, γ-caprolactam, β-Caprolactam, and the like.

Furthermore, the example of the oxime blocking agent includes formaldoxime, acetoaldoxime, acetoxime, methyl ethyl ketoneoxime, diacetylmonooxime, cyclohexaneoxime, and the like.

Furthermore, the example of the glycol ether blocking agent includes ethylene glycol monoalkyl ether blocking agents such as ethylene glycol monomethyl ether, ethylene glycol monoethyl ether, ethylene glycol monobutyl ether, diethylene glycol monomethyl ether and ethylene glycol mono-2-ethylhexyl ether; and propylene glycol monoalkyl ether blocking agents such as propylene glycol monomethyl ether and propylene glycol monoethyl ether, etc.

Other active hydrogen-containing blocking agent (hereinafter, merely called as “active hydrogen-containing blocking agent”) can be used in combination in addition to the above-mentioned glycol blocking agent, lactam blocking agent, oxime blocking agent or a glycol ether blocking agent as the blocking agent. The example of these active hydrogen-containing blocking agents includes phenol blocking agents such as phenol, cresol, xylenol, chlorophenol and ethylphenol; active methylene blocking agents such as ethyl acetoacetate and acetyl acetone; alcohol blocking agents such as methanol, ethanol, propaol, butanol, amyl alcohol, benzyl alcohol, methyl glycolate, butyl glycolate, diacetone alcohol, methyl lactate and ethyl lactate; mercaptane blocking agents such as butyl mercaptane, hexyl mercaptane, t-butyl mercaptane, thiophenol, methylthiophenol and ethylthiophenol; acid amide blocking agents such as acetamide and benamide; imide blocking agents such as succinimde and maleimide; imidazole blocking agents such as imidazole and 2-ethylimidazole; pyrazole blocking agents; and triazole blocking agents, etc.

These blocking agents used for preparation of the blocked polyisocyanate are generally used in equivalent as the isocyanate group of the polyisocyanate.

The compounding ratio of the glycol blocking agent, lactam blocking agent, oxime blocking agent or glycol ether blocking-agent to the active hydrogen-containing blocking agent is selected based on the viewpoints of curing property and storage stability.

The blocked isocyanate curing agent (2) may preferably be a blocked isocyanate curing agent in which aromatic-polyisocyanate is blocked with at least a lactam blocking agent, a glycol ether blocking agent or a glycol blocking agent, or a blocked isocyanate curing agent in which alicyclic polyisocyanate is blocked with at least an oxime blocking agent or a glycol ether blocking agent. Herein, when aromatic polyisocyanate is used as the polyisocyanate, it may be more preferable because technical effect of enhancing the throwing power of the electrodeposition coating composition can be obtained. The electrodeposition coating composition in the present invention is a coating composition in which zinc oxide is contained in an amount of 0.25 to 5 parts by weight based on 100 parts by weigh of the pigment. Furthermore, extremely good low temperature curing property can be obtained by using the blocked isocyanate curing agent (2), as the blocked isocyanate curing agent (2) used for preparation of the coating composition of the present invention.

Other Components

The electrodeposition coating composition in the present invention may contain organic tin compounds such as dibutyltin laurate, dinutyltin oxide and dioctyltin oxide; amines such as N-methylmorpholine and metals such as strontium, cobalt, copper and bismuth and metal salts thereof, as a catalyst, in addition to the above-mentioned components. These can act as a catalyst for dissociation of the blocking agent. The concentration of the catalyst may preferably be 0.1 to 6 parts by weight based on 100 parts by weight of the solid content of the binder resin in the electrodeposition coating composition.

Preparation of Electrodeposition Coating Composition

The electrodeposition coating composition in the present invention can be prepared by dispersing the binder resin emulsion, the pigment dispersed paste and optional catalyst in an aqueous medium. The binder resin emulsion contains the amine-modified epoxy resin (1) and the blocked isocyanate curing agent (2).

The preparation of the binder resin emulsion can be performed by a conventional method. A preferable preparation method includes a method of mixing the amine-modified epoxy resin (1), the blocked isocyanate curing agent (2) and an aqueous medium containing a neutralizing acid to emulsify the binder resin. The neutralizing acid is acid neutralizing the amine-modified epoxy resin and improving the dispersibility of the binder resin emulsion. The neutralizing acid is inorganic acid or organic acid such as hydrochloric acid, nitric acid, phosphoric acid, formic acid, acetic acid or lactic acid.

When the amount of the neutralizing acid contained in the coating composition is large, the neutralization rate of the amine-modified epoxy resin is high and the affinity of the binder resin emulsion to an aqueous medium is heightened. Thus, dispersion stability of the coating composition is elevated. This means characteristic that the binder resin is hardly deposited an article to be coated during electrodeposition coating and the deposition property of a solid content of the coating composition is lowered.

In contrast, when the amount of the neutralizing acid contained in the coating composition is small, the neutralization rate of the amine-modified epoxy resin is lowered, the affinity of the binder resin emulsion for an aqueous medium is lowered and the dispersion stability of the coating composition is reduced. This means characteristic that the binder resin is easily deposited for an article to be coated during coating and the deposition property of a solid content of the coating composition is increased.

The amount of the neutralizing acid used for preparation of the binder resin emulsion may preferably be 10 to 30 mg based on 100 g of the solid content weight of the binder resin emulsion. Herein, the solid content weight of the binder resin emulsion is equivalent to the solid content weight of the amine-modified epoxy resin (1) and the blocked isocyanate curing agent (2). When the weight of the neutralizing acid is less than 10 mg equivalent, affinity to water may not be adequate and dispersion to water may not be possible or stability of the coating composition may be insufficient. When it exceeds 30 mg equivalent, the quantity of electricity required for deposition may be increased, the depositing property of the solid content of the coating composition may be lowered and its throwing power may be inferior.

Furthermore, “the amount of the neutralizing acid” in the present specification is the amount of acid used for neutralizing the amine-modified epoxy resin in emulsification, represented by mg equivalent number based on 100 g of the solid content weight of the binder resin emulsion contained in the coating composition, and is designated as MEQ(A).

The amount of the blocked isocyanate curing agent (2) must be sufficient for reacting with an active hydrogen-containing functional group such as the primary, secondary and tertiary amino groups and a hydroxyl group in the amine-modified epoxy resin (1) at the time of curing, and providing a good cured film. In general, the solid content weight ratio (epoxy resin/curing agent) of the amine-modified-epoxy resin to the blocked isocyanate curing agent is generally in a range of 90/10 to 50/50 and preferably in a range of 80/20 to 65/35.

An organic solvent is necessary as a solvent in synthesizing resin components such as the amine-modified epoxy resin, the blocked isocyanate curing agent and the pigment dispersed resin and complicated operation is required for complete removal. Consequently, an intended amount of the organic solvent is contained in the electrodeposition coating composition. Since the organic solvent is contained in the binder resin, the flowability of the coating film at film formation is improved and the smoothness of the coating film is improved.

The organic solvent usually contained in the electrodeposition coating composition includes ethylene glycol monobutyl ether, ethylene glycol monohexyl ether, ethylene glycol monoethylhexyl ether, propylene glycol monobutyl ether, dipropylene glycol monobutyl ether, propylene glycol monophenyl ether and the like. These organic solvents may be included in an aqueous medium used for preparation of the cationic electrodeposition coating composition.

The coating composition can contain additives for a coating composition usually used such as a plasticizer, a surfactant, an antioxidant and an ultraviolet absorbent in addition to the above-mentioned compounds.

Electrodeposition Coating (Electrocoating)

The electrodeposition coating composition of the present invention is coated on an article to be coated by electrodeposition to form an electrodeposition coating film. The article to be coated is not specifically limited so far as it is electroconductive, and for example, an iron plate, a steel plate, an aluminum plate and a surface treated article thereof, and a molded article thereof can be mentioned.

The electrodeposition coating of the cationic electrodeposition coating composition is carried out by usually applying voltage of 50 to 450 V between an anode and a cathode which is the above-mentioned article to be coated. When applied voltage is less than 50 V, electrodeposition is inadequate and when it exceeds 450 V, the coating film is broken and appearance is abnormal. At electrodeposition coating, the bath liquid temperature of the coating composition is usually adjusted at 10 to 45° C. at electrodeposition coating.

The electrodeposition coating process of the cationic electrodeposition coating composition is composed of a step of immersing an article to be coated in the cationic electrodeposition coating composition and a step of applying voltage between an anode and a cathode using the above-mentioned article to be coated as the cathode and depositing a coating film. Furthermore, the time applying voltage can be generally 2 to 4 minutes depending on electrodeposition condition. The “electrodeposition coating film” in the present invention means an uncured coating film after electrodeposition coating, that is, after the step of depositing a coating film and before curing by baking.

The film thickness of the electrodeposition coating film can be generally formed in a range of 5 to 25 μm. When the film thickness is less than 5 μm, it may bring inadequate anticorrosive property.

After completion of the electrodeposition process, the electrodeposition coating film obtained by the above-description or optionally rinsed with water, is cured by baking at 120 to 260° C. and preferably 140 to 220° C. for 10 to 30 minutes to obtain a cured electrodeposition coating film.

### EXAMPLES

The present invention is more specifically illustrated according to Examples, but the present invention is not limited to these Examples. “Parts” and “%” in Examples are based on weight unless otherwise noticed.

### Production Example 1

### Production of Amine-Modified Epoxy Resin (i)

Into a flask equipped with a stirrer, a cooling tube, a nitrogen introducing tube, a thermometer and a dropping funnel, 940 parts of liquid epoxy, 61.4 parts of methyl isobutyl ketone (hereinafter, abbreviated as MIBK) and 24.4 parts of methanol were charged. After the temperature of the reaction mixture was raised from room temperature to 40° C., 0.01 part of dibutyltin laurate and 21.75 parts of tolylene diisocyanate (hereinafter, abbreviated as TDI) were charged. The mixture was reacted at 40 to 45° C. for 30 minutes. The reaction was continued until absorption based on the isocyanate group was disappeared.

To the above-mentioned reaction product, 82.0 parts of polyoxyethylene bisphenol A ether and 125.0 parts of diphenylmethane-4,4′-diisocyanate were added. The reaction was carried out at 55° C. to 60° C. and continued until absorption based on the isocyanate group was disappeared in the measurement of IR spectrum. Successively, the temperature of the mixture was raised, 2.0 parts of N,N-dimethylbenzylamine was charged at 100° C., they were kept at 130° C., methanol was removed using a fractionation paragraph and they were reacted to obtain an epoxy equivalent of 284.

Then, the mixture was diluted to a non-volatile content of 95% with MIBK, the reaction mixture was cooled and 268.1 parts of bisphenol A and 93.6 parts of 2-ethylhexanoic acid were charged. The reaction was carried out at 120° C. to 125° C. When an epoxy equivalent was 1320, it was diluted to a non-volatile content of 85% with MIBK and the reaction mixture was cooled. 93.6 Parts of a compound blocking the primary amine of diethylenetriamine with MIBK and 65.2 parts of N-methylethanolamine were added and the mixture was reacted at 120° C. for 1 hour. Then, an oxazolidone ring-containing modified epoxy resin having a cationic group (resin solid content: 85%) was obtained.

### Production Example 2

### Production of Blocked Polyisocyanate Curing Agent (A)

1330 Parts of crude MDI, 276.1 parts of MIBK and 2 parts of dibutyltin laurate were charged in a reaction vessel, the mixture was heated until 85 to 95° C., and then, 1170 parts of the ethylene glycol monobutyl ether solution (equivalent ratio of 20/80) of caprolactam was added dropwise over 2 hours. After the completion of dropwise addition, the mixture was raised to 100° C. and the temperature was kept for 1 hour. It was confirmed that absorption based on an isocyanate group was disappeared in the measurement of IR spectrum, and then, 347.6 parts of MIBK was charged to obtain a blocked polyisocyanate curing agent.

### Production Example 3

### Production of Pigment Dispersed Resin

Into a reaction vessel equipped with a stirrer, a cooling tube, a nitrogen introducing tube and a thermometer, 2220 parts of isophorone diisocyanate (hereinafter, abbreviated as IPDI) and 342.1 parts of MIBK were charged, temperature was raised, 2.2 parts of dibutyltin laurate was charged at 50° C. and 878.7 parts of methyl ethyl ketone oxime (hereinafter, abbreviated as MEK oxime) was charged at 60° C. Then, the mixture was kept at 60° C. for 1 hour, and it was confirmed that an NCO equivalent was 348, and 890 parts of diethanolamine was charged. The mixture was kept at 60° C. for 1 hour, and after confirming that NCO peak was disappeared in IR, 1872.6 parts of 50% lactic acid and 495 parts of deionized water were charged while cooling so as not to exceed 60° C. to obtain a quaternizing agent. Then, 870 parts of TDI and 49.5 parts of MIBK were charged in a different reaction vessel and 667.2 parts of 2-ethylhexanol was added dropwise over 2.5 hours so as not to be 50° C. or more. After completion of the dropwise addition, 35.5 parts of MIBK was charged and a temperature was kept for 30 minutes. Then, it was confirmed that an NCO equivalent was 330 to 370 and half blocked polyisocyanate was obtained.

Into a reaction vessel equipped with a stirrer, a cooling tube, a nitrogen introducing tube and a thermometer, 940.0 parts of liquid epoxy was diluted with 38.5 parts of methanol and then, 0.1 part of dibutyltin laurate was added thereto. After the temperature of the mixture was raised to 50° C., 87.1 parts of TDI was furthermore charged and a temperature was furthermore raised. Thereto was added 1.4 Parts of N,N-dimethylbenzylamine at 100° C. and a temperature was kept at 130° C. for 2 hours. At this time, methanol was fractionated by a fractionation tube. This was cooled to 115° C., MIBK was charged until the concentration of solid content was 90%, then 270.3 parts of bisphenol A and 39.2 parts of 2-ethylhexanoic acid were charged, the mixture was stirred by heating at 125° C. for 2 hours, then 516.4 parts of the fore-mentioned half blocked polyisocyanate was added dropwise over 30 minutes and the mixture was stirred by heating for 30 minutes. 1506 parts of polyoxyethylene bisphenol A ether was gradually added to dissolve the mixture. After cooling to 90° C., the above-mentioned quaternizing agent was added, the temperature was kept at 70 to 80° C., and an acid value of 2 or less was confirmed to obtain a resin for a dispersing pigment (resin solid content; 30%).

### Production Example 4

### Production of Pigment Dispersed Paste (a)

106.9 parts of the resin for dispersing a pigment obtained in Production Example 3, 0.25 part of zinc oxide, 1.6 parts of carbon black, 39.75 parts of kaolin, 55.4 parts of titanium dioxide, 3 parts of aluminum phosphomolybdate and 13 parts of deionized water were charged in a sand grind mill, and the mixture was dispersed until its particle size was 10 μm or less to obtain a pigment dispersed paste (solid content; 60%) The content of zinc oxide was 0.25 part by weight based on 100 parts by weight of the pigment.

### Production Example 5

### Production of Pigment Dispersed Paste (b)

106.9 Parts of the resin for dispersing a pigment obtained in Production Example 3, 0.5 part of zinc oxide, 1.6 parts of carbon black, 39.5 parts of kaolin, 55.4 parts of titanium dioxide, 3 parts of aluminum phosphomolybdate and 13 parts of deionized water were charged in a sand grind mill, and the mixture was dispersed until its particle size was 10 μm or less to obtain a pigment dispersed paste (solid content; 60%). The content of zinc oxide was 0.5 part by weight based on 100 parts by weight of the pigment.

### Production Example 6

### Production of Pigment Dispersed Paste (c)

106.9 Parts of the resin for dispersing a pigment obtained in Production Example 3, 3 part of zinc oxide, 1.6 parts of carbon black, 37 parts of kaolin, 55.4 parts of titanium dioxide, 3 parts of aluminum phosphomolybdate and 13 parts of deionized water were charged in a sand grind mill, and the mixture was dispersed until its particle size was 10 μm or less to obtain a pigment dispersed paste (solid content; 60%). The content of zinc oxide was 3 parts by weight based on 100 parts by weight of the pigment.

### Production Example 7

### Production of Pigment Dispersed Paste (d)

106.9 Parts of the resin for dispersing a pigment obtained in Production Example 3, 5 part of zinc oxide, 1.6 parts of carbon black, 35 parts of kaolin, 55.4 parts of titanium dioxide, 3 parts of aluminum phosphomolybdate and 13 parts of deionized water were charged in a sand grind mill, and the mixture was dispersed until its particle size was 10 μm or less to obtain a pigment dispersed paste (solid content; 60%). The content of zinc oxide was 5 parts by weight based on 100 parts by weight of the pigment.

### Comparative Production Example 1

### Production of Pigment Dispersed Paste (e)

106.9 Parts of the resin for dispersing a pigment obtained in Production Example 3, 1.6 parts of carbon black, 40 parts of kaolin, 55.4 parts of titanium dioxide, 3 parts of aluminum phosphomolybdate and 13 parts of deionized water were charged in a sand grind mill, and the mixture was dispersed until its particle size was 10 μm or less to obtain a pigment dispersed paste (solid content; 60%). The content of zinc oxide was 0 part by weight based on 100 parts by weight of the pigment.

### Comparative Production Example 2

### Production of Pigment Dispersed Paste (f)

106.9 Parts of the resin for dispersing pigment obtained in Production Example 3, 10 parts of zinc oxide, 1. 6 parts of carbon black, 30 parts of kaolin, 55.4 parts of titanium dioxide, 3 parts of aluminum phosphomolybdate and 13 parts of deionized water were charged in a sand grind mill, and the mixture was dispersed until its particle size was 10 μm or less to obtain a pigment dispersed paste (solid content; 60%). The content of zinc oxide was 10 parts by weight based on 100 parts by weight of the pigment.

### Comparative Production Example 3

### Production of Pigment Dispersed Paste (g)

106.9 Parts of the resin for dispersing a pigment obtained in Production Example 3, 0.125 part of zinc oxide, 1.6 parts of carbon black, 39.875 parts of kaolin, 55.4 parts of titanium dioxide, 3 parts of aluminum phosphomolybdate and 13 parts of deionized water were charged in a sand grind mill, and the mixture was dispersed until its particle size was 10 μm or less to obtain a pigment dispersed paste (solid content; 60%). The content of zinc oxide was 0.125 part by weight based on 100 parts by weight of the pigment.

### Comparative Production Example 4

### Production of Pigment Dispersed Paste (h)

106.9 Parts of the resin for dispersing a pigment obtained in Production Example 3, 6 parts of zinc oxide, 1.6 parts of carbon black, 34 parts of kaolin, 55.4 parts of titanium dioxide, 3 parts of aluminum phosphomolybdate and 13 parts of deionized water were charged in a sand grind mill, and the mixture was dispersed until its particle size was 10 μm or less to obtain a pigment dispersed paste (solid content; 60%). The content of zinc oxide was 6 parts by weight based on 100 parts by weight of the pigment. μm

### Comparative Production Example 5

### Production of Amine-Modified Epoxy Resin (ii)

Into a flask equipped with a stirrer, a cooling tube, a nitrogen introducing tube, a thermometer and a dropping funnel, 940 parts of liquid epoxy, 61.4 parts of methyl isobutyl ketone and 24.4 parts of methanol were charged. After the temperature of the reaction mixture was raised from room temperature to 40° C., 0.01 part of dibutyltin laurate and 21.75 parts of tolylene diisocyanate (hereinafter, abbreviated as TDI) were charged. The mixture was reacted at 40 to 45° C. for 30 minutes. The reaction was continued until absorption based on the isocyanate group was disappeared in the measurement of IR spectrum.

To the above-mentioned reaction product, 82.0 parts of polyoxyethylene bisphenol A ether and 125.0 parts of diphenylmethane-4,4′-diisocyanate were added. The reaction was carried out at 55° C. to 60° C. and continued until absorption based on the isocyanate group was disappeared in the measurement of IR spectrum. Successively, the temperature of the mixture was raised, 2.0 parts of N,N-dimethylbenzylamine was charged at 100° C., the temperature was kept at 130° C., methanol was removed using a fractionation paragraph and they were reacted to obtain an epoxy equivalent of 284.

Then, the mixture was diluted to a non-volatile content of 95% with MIBK, the reaction mixture was cooled and 432 parts of 2-ethylhexanoic acid was charged. The reaction was carried out at 120° C. to 125° C. When an epoxy equivalent was 1320, it was diluted to a non-volatile content of 85% with MIBK and the reaction mixture was cooled. 93.6 parts of a compound blocking the primary amine of diethylenetriamine with MIBK and 65.2 parts of N-methylethanolamine were added and the mixture was reacted at 120° C. for 1 hour. Then, an oxazolidone ring-containing modified epoxy resin having a cationic group (resin solid content: 85%) was obtained.

### Example 1

### Production of Cationic Electrodeposition Coating Composition

The oxazolidone ring-containing modified epoxy resin having a-cationic group which was obtained in Production Example 1 and the blocked polyisocyanate curing agent A obtained in Production Example 2 were homogeneously mixed so as to be a solid content ratio of 70/30. Furthermore, a mixture in which 2-ethylhexylglycol was added by 3% for a resin solid content was neutralized with glacial acetic acid so that mg equivalent of acid per 100 g of the resin solid content was 33, and ion exchanged water was gradually added to dilute the mixture. A binder resin emulsion with a solid content of 36% was obtained by removing MIBK under reduced pressure.

1730 Parts of the emulsion, 295 parts of the pigment dispersed paste (a) obtained in Production Example 4, 1970 parts of ion exchanged water, 20 parts of 10% aqueous cerium acetate solution and 10 parts of dibutyltin oxide were mixed to obtain a cationic electrodeposition coating composition with a solid content of 20% by weight.

Electrodeposition Coating

Electrodeposition coating was carried out in the cationic electrodeposition coating composition obtained, on a cold-rolled steel plate (JIS G3141 Specification Product, 150×70×0.8 mm) subjected to a zinc phosphate chemical treatment (SD-5350, manufactured by Nippon Paint Co., Ltd.) so that the film thickness of a dried coating film was 25 μm, and this was baked and cured at 160° C. for 25 minutes to form a coating film.

### Examples 2 to 4 and Comparative Examples 1 to 5

Cationic electrodeposition coating compositions were prepared in the same manner as Example 1 except that the pigment dispersed paste, amine-modified epoxy resin and blocked isocyanate curing agent shown in the following Table 1 or 2 were used. Electrodeposition coating was carried out in the same manner as Example 1 using the cationic electrodeposition coating compositions thus obtained.

TABLE 1

| | | Example 1 | Example 2 | Example 3 | Example 4 |
|---|---|---|---|---|---|
| Pigment dispersed | | (a) | (b) | (c) | (d) |
| paste | | | | | |
| Binder | Amine- | (i) | (i) | (i) | (i) |
| resin | modified | | | | |
| emulsion | epoxy | | | | |
| | resin | | | | |
| | Blocked | (A) | (A) | (A) | (A) |
| | isocyanate | | | | |
| | curing | | | | |
| | agent | | | | |

TABLE 2

| | | Comparative | Comparative | Comparative | Comparative | Comparative |
|---|---|---|---|---|---|---|
| | | Example 1 | Example 2 | Example 3 | Example 4 | Example 5 |
| Pigment dispersed | | (e) | (e) | (f) | (g) | (h) |
| paste | | | | | | |
| Binder | Amine- | (i) | (ii) | (i) | (i) | (i) |
| resin | modified | | | | | |
| emulsion | epoxy | | | | | |
| | resin | | | | | |
| | Blocked | (A) | (A) | (A) | (A) | (A) |
| | isocyanate | | | | | |
| | curing | | | | | |
| | agent | | | | | |

The following items were evaluated for the above-described Examples and Comparative Examples. The results are shown in Tables 3 and 4.

Measurement of Ra Value of Coating Film

The Ra values of coating films obtained by Examples and Comparative Examples were measured in accordance with JIS-B0601-2001 using an evaluation type surface roughness measuring machine (SURFTEST SJ-201P manufactured by Mitsutoyo Corporation). Ra was measured 7 times using cutoff with a width of 2.5 mm (the number of partition was 5) and Ra value was obtained by top and bottom erasing average. Furthermore, these Ra values show that the smaller the value is, the less the unevenness on surface is and the better the coating film appearance is.

Gas Pinhole Performance

Electrodeposition coating on a melt zinc coated cold-rolled steel plate was carried out for 175 seconds after raising voltage to 280 V for 5 seconds, and then, it was rinsed with water to be baked at 170° C. for 25 minutes. The coating surface state of the tested plate was observed and the number of gas pinholes was examined.

Throwing-Power

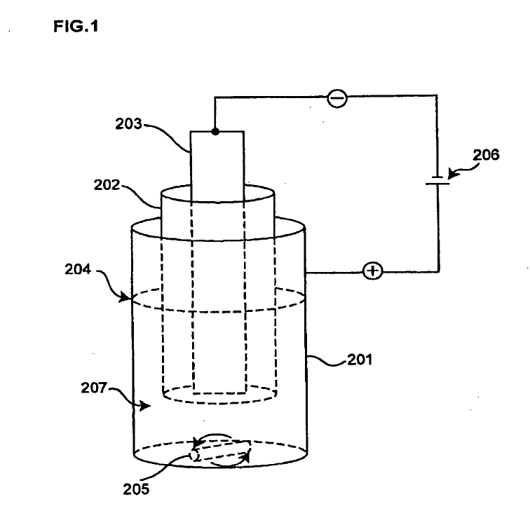

Throwing powers were measured by a measurement device shown in FIG. 1, using the cationic electrodeposition coating compositions prepared in Examples and Comparative Examples. 3 Litter of each of electrodeposition coating compositions 207 which were prepared in Examples and Comparative examples was charged in an electroconductive electrodeposition coating container 201 (an inner diameter of 105 mm and a height of 370 mm) and it was stirred with a stirrer 205. Zinc phosphate treated steel plates (JIS G 3141 SPCC-SD treated with SURFDINE SD-2500) were used as evaluation plates 203 (dimension; 15 mm×400 mm, a thickness of 0.7 mm). A pipe 202 (an inner diameter of 17.5 mm, a length of 375 mm and a thickness of 1.8 mm) with both ends release type was arranged in the electrodeposition coating container 201 and the evaluation plate 203 was arranged in the pipe so as not to be brought in contact with the pipe. The evaluation plate 203 and the pipe 202 were immersed by 30 cm in the electrodeposition coating composition.

Electrocoating was carried out by using the electrodeposition coating container 201 as an anode and the evaluation plate 203 as a cathode and applying voltage. The coating was carried out by raising voltage from the start of application to 200 V over 30 seconds and then, keeping an intended voltage for 150 seconds. The temperature of the bath was adjusted at 28° C. at this time. After the evaluation plate after the coating was rinsed with water, it was baked at 150° C. for 25 minutes and the film thickness of the evaluation plate was measured. A position at which a film thickness on the evaluation plate was 6 μm was marked and the distance (cm) of the marked position from the bottom surface portion of the evaluation plate was measured. The coating film of the evaluation plate was generally thick at the bottom surface portion (the inlet portion of the pipe) and the farther the position is, the thinner the film is; therefore it can be said that the farther from the bottom surface portion the position of 6 μm is, the better the throwing power is.

A: The distance of a position at which a film thickness on the evaluation plate is 6 μm, from the bottom surface portion of the evaluation plate is 18 cm or more and less than 30 cm.
B: The distance of a position at which a film thickness on the evaluation plate is 6 μm, from the bottom surface portion of the evaluation plate is 15 cm or more and less than 18 cm.
C: The distance of a position at which a film thickness on the evaluation plate is 6 μm, from the bottom surface portion of the evaluation plate is less than 15 cm.

Salt Spray Resistance Test

A salt spray resistance test was carried out in accordance with JIS K 5600 7-1 using coating samples having coating films-obtained in Examples and Comparative Examples. Crosscut was applied to all of the coating samples to carry out the test. The width (mm) of rust or blister produced from the crosscut portion is shown in Tables 3 and 4. It can be evaluated that the smaller the width (mm) is, the more superior the corrosion resistance is.

Coating Stability Test

### Particle Size Measurement

Particle size of pigment dispersed pastes used for the preparation of the electrodeposition coating compositions of Examples and Comparative Examples was measured using a grind gauge. Then, the pigment dispersed paste was charged in a can whose inner surface was coated and it was stored in an incubator at 40° C. for 30 days. After the storage, its lid was opened and the particle size of the pigment dispersed pastes was measured again using a grind gauge. The result is shown in Tables 3 and 4.

Viscosity Measurement

The pigment dispersed paste used for the preparation of the electrodeposition coating compositions of Examples and Comparative Examples was charged in cans whose inner surface was coated and was stored in an incubator at 40° C. for 30 days. After the storage, its lid was opened and the viscosity of the coating compositions was measured using a viscometer (manufactured by UESHIMA Seisakusho K.K., Stomer viscometer was used and measured at 25° C.). The result is shown in Tables 3 and 4.

TABLE 3

| | | Example 1 | Example 2 | Example 3 | Example 4 |
|---|---|---|---|---|---|
| Amount (parts) of zinc oxide contained | | 0.25 | 0.5 | 3 | 5 |
| in 100 parts of pigment | | | | | |
| Parts by weight of pigment per 100 | | 16.7 | 16.7 | 16.7 | 16.7 |
| parts by weight of a solid content of | | | | | |
| the coating composition | | | | | |
| Ra value of coating film | | 0.2 | 0.2 | 0.2 | 0.2 |
| Coating | Gas pinhole performance | 0 | 0 | 0 | 0 |
| workability | (piece) | | | | |
| | Throwing power (cm) | 20 | 20 | 20 | 20 |
| | Grade of Throwing power | A | A | A | A |

| Salt spray resistance test | | | 2 | 2 | 2 | 2 |
|---|---|---|---|---|---|---|
| (peeling width mm) | | | | | | |
| Storage stability | Particle | Before | 3 | 3 | 3 | 3 |
| of pigment | size | storage | | | | |
| dispersed paste | (μm) | After | 5 | 5 | 5 | 5 |
| | | storage | | | | |

| | | | | |
|---|---|---|---|---|
| Viscosity (KU) | 60 | 60 | 60 | 60 |

TABLE 4

| | | | Comparative | Comparative | Comparative | Comparative | Comparative |
|---|---|---|---|---|---|---|---|
| | | | Example 1 | Example 2 | Example 3 | Example 4 | Example 5 |
| Amount (parts) of zinc oxide contained | | | 0 | 0 | 10 | 0.125 | 6 |
| in 100 parts of pigment | | | | | | | |
| Parts by weight of pigment per 100 | | | 16.7 | 16.7 | 16.7 | 16.7 | 16.7 |
| parts by weight of a solid content of | | | | | | | |
| the coating composition | | | | | | | |
| Ra value of coating film | | | 0.35 | 0.2 | 0.2 | 0.25 | 0.2 |
| Coating | Gas pinhole performance | | 5 | 0 | 0 | 2 | 0 |
| workability | (piece) | | | | | | |
| | Throwing power (cm) | | 20 | 15 | 20 | 20 | 20 |
| | Grade of Throwing power | | A | B | A | A | A |
| Salt spray resistance test | | | 2 | 10 | 2 | 2 | 2 |
| (peeling width mm) | | | | | | | |
| Storage stability | Particle | Before | 3 | 3 | 3 | 3 | 3 |
| of pigment | size | storage | | | | | |
| dispersed paste | (μm) | After | 15 | 15 | 5 | 6 | 5 |
| | | storage | | | | | |

| | | | | | |
|---|---|---|---|---|---|
| Viscosity (KU) | 60 | 60 | 65 | 60 | 63 |

As cleared from the above-mentioned Tables 3 and 4, the process for forming an electrodeposition coating film of the present invention was superior in gas pinhole performance and throwing power and the obtained coating film was superior in corrosion resistance and coating film appearance. Furthermore, it was also confirmed that the storage stability of the pigment dispersed paste used for preparation of the electrodeposition coating composition is excellent. On the other hand, Comparative Example 1 which did not contain zinc oxide in a pigment and Comparative Example 4 with a small amount of zinc oxide were inferior in the gas pinhole performance and the coating film appearance of the obtained coating film. Furthermore, Comparative Example 2 that did not contain zinc oxide in the pigment and contained a large amount of a plastic content in a binder resin was superior in gas pinhole performance, but inferior in corrosion resistance. The particle size of the pigment dispersed paste used for the preparation of the electrodeposition coating composition that was used for Comparative Examples 1 and 2 was raised by storage and they were inferior in the storage stability. Comparative Examples 3 and 5 were examples in which zinc oxide was contained in a larger amount, and had a defect such that the viscosity of the pigment dispersed paste was increased by storage.

### INDUSTRIAL APPLICABILITY

According to the present invention, the generation of the gas pinhole can be reduced without preparing the electrodeposition coating composition containing a specific binder resin in the formation of an electrodeposition coating film. Furthermore, the process for forming an electrodeposition coating film of the present invention has also an advantage that a coating film superior in coating film appearance is obtained. The present invention has also an advantage that the thickening viscosity of the pigment dispersed paste can be reduced by using pigment containing a specific amount of zinc oxide in the electrodeposition coating composition and the storage stability of the pigment dispersed paste can be improved. Since the storage stability of the pigment dispersed paste is improved, there is an industrial advantage that the preparation of the electrodeposition coating composition becomes easier.

1. A process for forming an electrodeposition coating film having reduction of generation of gas pinhole, comprising a step of electrocoating by immersing an article to be coated in a cationic electrodeposition coating composition, wherein,
the cationic electrodeposition coating composition comprises 10 to 30 parts by weight of a pigment comprising zinc oxide based on 100 parts by weight of a solid content of the coating composition, and
the content of zinc oxide contained in the pigment is 0.25 to 5 parts by weight based on 100 parts by weight of the pigment.

2. The process for forming an electrodeposition coating film according to claim 1, wherein the cationic electrodeposition coating composition is a cationic electrodeposition coating composition comprising an amine-modified epoxy resin (1), a blocked isocyanate curing agent (2) and a pigment comprising zinc oxide (3), and
at least one kind selected from the group consisting of aromatic polyisocyanate, aliphatic polyisocyanate and alicyclic polyisocyanate is contained as polyisocyanate constituting the blocked isocyanate curing agent (2), and at least one kind selected from the group consisting of a glycol blocking agent, a lactam blocking agent, an oxime blocking agent and a glycol ether blocking agent is contained as a blocking agent for blocking the polyisocyanate.

3. The process for forming an electrodeposition coating film according to claim 1, wherein the blocked isocyanate curing agent (2) is a blocked isocyanate curing agent in which aromatic isocyanate is blocked with at least a lactam blocking agent, a glycol ether blocking agent or a glycol blocking agent, or a blocked isocyanate curing agent in which alicyclic polyisocyanate is blocked with at least an oxime blocking agent or a glycol ether blocking agent.

4. The process for forming an electrodeposition coating film according to claim 1, wherein the cationic electrodeposition coating composition is a cationic electrodeposition coating composition prepared by mixing a binder resin emulsion comprising the amine-modified epoxy resin (1) and the blocked isocyanate curing agent (2) with a pigment dispersed paste comprising the pigment (3) comprising zinc oxide.

5. A coating film obtained by the process for forming an electrodeposition coating film according to claim 1.

6. A process for improving gas pinhole performance at electrodeposition coating, coating film appearance, and storage stability of a pigment dispersed paste, wherein the cationic electrodeposition coating composition used in an electrocoating step comprises 10 to 30 parts by weight of pigment comprising zinc oxide based on 100 parts by weight of a solid content of the coating composition, and the content of zinc oxide contained in the pigment is 0.25 to 5 parts by weight based on 100 parts by weight of the pigment.

7. The process for forming an electrodeposition coating film according to claim 2, wherein the cationic electrodeposition coating composition is a cationic electrodeposition coating composition prepared by mixing a binder resin emulsion comprising the amine-modified epoxy resin (1) and the blocked isocyanate curing agent (2) with a pigment dispersed paste comprising the pigment (3) comprising zinc oxide.

8. The process for forming an electrodeposition coating film according to claim 3, wherein the cationic electrodeposition coating composition is a cationic electrodeposition coating composition prepared by mixing a binder resin emulsion comprising the amine-modified epoxy resin (1) and the blocked isocyanate curing agent (2) with a pigment dispersed paste comprising the pigment (3) comprising zinc oxide.

9. A coating film obtained by the process for forming an electrodeposition coating film according to claim 2.

10. A coating film obtained by the process for forming an electrodeposition coating film according to claim 3.

11. A coating film obtained by the process for forming an electrodeposition coating film according to claim 4.

12. A coating film obtained by the process for forming an electrodeposition coating film according to claim 7.

13. A coating film obtained by the process for forming an electrodeposition coating film according to claim 8.
